(19) United States
(12) Patent Application Publication
(10) Pub. No.: US 2007/0227930 A1
(43) Pub. Date: Oct. 4, 2007

(54) Antimicrobial Product Combination

(76) Inventors: Steven E. Bromberg, Oakland, CA (US); Bruce K. Bitowft, Oakland, CA (US); Elizabeth Crane, Oakland, CA (US); Maha El-Sayed, Oakland, CA (US); Daniel A. Huitt, Oakland, CA (US); Andreas Nguyen, Oakland, CA (US); Ricardo Ruiz de Gopegui, Oakland, CA (US); Doris S. Shieh, Oakland, CA (US); William L. Smith, Oakland, CA (US); Julie Timberman, Oakland, CA (US)

Correspondence Address: THE CLOROX COMPANY, P.O. BOX 24305, OAKLAND, CA, 94623-1305, US

(21) Appl. No.: 11/277,642

(22) Filed: Mar. 28, 2006

(51) Int. Cl. B65D 85/42; A01N 59/08; A01N 31/08

(52) U.S. Cl. 206/528; 424/661; 514/731

(57) ABSTRACT

A system and display for use in a mass retail or institutional environment. The system comprises displaying multiple products in an adjacent fashion, in a row, on a shelf, or on adjacent shelves where each product has a common antimicrobial active. One product is for use on hard surfaces and has a larger particle size. Another product is for use in the air or on soft surfaces and has a smaller particle size. In one example, the antimicrobial active is dilute hypochlorite.

### BACKGROUND OF THE INVENTION

1. Field of the Invention

This invention relates to shelving and displays for marketing a combination of antimicrobial products. More specifically, the invention comprises using a particular retail shelf display arrangement and particular products having a common antimicrobial active. The invention also relates to selling particular products having a common antimicrobial active in multi-packs.

2. Description of the Related Art

Manufacturers of consumer goods often produce multiple products that are each focused on treating specific surfaces or one product that broadly treats multiple surfaces. Where antimicrobial products and antimicrobial product claims are involved, the products must be designed to pass rigorous testing protocol and be effective on each surface claimed. They must also meet consumer demands for safety and efficacy. Because of these limitations, it is difficult to design a single product to meet all the regulatory and consumer requirements for a variety of surfaces.

U.S. Pat. No. 6,936,220 to Hoshino et al. discloses applying a mist of dilute chlorine-containing oxidizing agent to a variety of surfaces. U.S. Pat. No. 5,749,924 to Murch et al. discloses oleate and phosphate compositions for fabric and hard surfaces. U.S. Pat. No. 5,336,500 to Richter et al. discloses unsaturated monocarboxylic acid and benzoic acid for both hard and soft surfaces. PCT Pub. WO 97/30586 to Romano et al. discloses a disinfecting composition having terpene, phenolic, and peroxide for use on hard and soft surfaces. U.S. Pat. No. 5,591,395 to Schroeder et al. describes compositions containing propylene glycol for air sanitization that are not appropriate for treatment of hard and soft surfaces.

While these technologies potentially cover broad product uses and usage areas, it is difficult to find one technology that is both safe and effective on several usage areas. Based on the prior art examples, the need exists for multiple products based on the same technology and having the same antimicrobial active and that are each designed to treat specific areas.

### SUMMARY OF THE INVENTION

In accordance with the above objects and those that will be mentioned and will become apparent below, one aspect of the present invention is a retail display combination comprising a set of products in product containers, each one of the set positioned adjacent at least one other of said set, said display comprising:
a. a first product container comprising a first dilute hypochlorite composition having less than 500 ppm hypochlorite in a first container;
b. a second product container comprising a second dilute hypochlorite composition having less than 500 ppm hypochlorite in a second container;
c. wherein said first container dispenses product having a first mean particle size distribution;
d. wherein said second container dispenses product having a second mean particle size distribution;
e. wherein said first product container is used on hard surfaces;
f. wherein said second product container has target uses selected from the group consisting of air, soft surfaces, and combinations thereof; and
g. wherein said second mean particle size distribution is smaller than said first mean particle size distribution.

In accordance with the above objects and those that will be mentioned and will become apparent below, another aspect of the present invention is system for performing cleaning tasks comprising:
a. a first product comprising a first liquid, antimicrobial composition in a first container;
b. a second product comprising a second liquid, antimicrobial composition in a second container;
c. wherein said first liquid, antimicrobial composition and said second liquid, antimicrobial composition comprise a common registered active ingredient;
d. wherein said first container dispenses product having a first mean particle size distribution;
e. wherein said second container dispenses product having a second mean particle size distribution;
f. wherein said first product is used on hard surfaces;
g. wherein said second product has target uses selected from the group consisting of air, soft surfaces, and combinations thereof; and
h. wherein said second mean particle size distribution is smaller than said first mean particle size distribution.

In accordance with the above objects and those that will be mentioned and will become apparent below, another aspect of the present invention is a retail display combination comprising a set of products in product containers, each one of the set positioned adjacent at least one other of said set, said display comprising:
a. a first product comprising a first antimicrobial composition in a first container;
b. a second product comprising a second antimicrobial composition in a second container;
c. wherein said first antimicrobial compostion and said second antimicrobial composition comprise a common registered active ingredient;
d. wherein said first container dispenses product having a first mean particle size distribution;
e. wherein said second container dispenses product having a second mean particle size distribution;
f. wherein said first product is used on hard surfaces;
g. wherein said second product has target uses selected from the group consisting of air, soft surfaces, and combinations thereof; and
h. wherein said second mean particle size distribution is smaller than said first mean particle size distribution.

Further features and advantages of the present invention will become apparent to those of ordinary skill in the art in view of the detailed description of preferred embodiments below.

### DETAILED DESCRIPTION

Before describing the present invention in detail, it is to be understood that this invention is not limited to particularly exemplified systems or process parameters that may, of course, vary. It is also to be understood that the terminology used herein is for the purpose of describing particular embodiments of the invention only, and is not intended to limit the scope of the invention in any manner.

All publications, patents and patent applications cited herein, whether supra or infra, are hereby incorporated by reference in their entirety to the same extent as if each individual publication, patent or patent application was specifically and individually indicated to be incorporated by reference.

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

It must be noted that, as used in this specification and the appended claims, the singular forms “a,” “an” and “the” include plural referents unless the content clearly dictates otherwise. Thus, for example, reference to a “surfactant” includes two or more such surfactants.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

In the application, effective amounts are generally those amounts listed as the ranges or levels of ingredients in the descriptions, which follow hereto. Unless otherwise stated, amounts listed in percentage (“%'s”) are in weight percent (based on 100% active) of the cleaning composition alone.

The term “surfactant”, as used herein, is meant to mean and include a substance or compound that reduces surface tension when dissolved in water or water solutions, or that reduces interfacial tension between two liquids, or between a liquid and a solid. The term “surfactant” thus includes anionic, nonionic, cationic and/or amphoteric agents.

Retail Display

The invention may comprise a display and method of displaying articles for sale in a retail environment, which method comprises displaying multiple product containers in an adjacent fashion, in a row, on a shelf, where each composition in the containers includes the same antimicrobial active. Importantly, the method may further comprise the step of displaying, in the combination of articles for sale, a combination of products consisting of at least two product types which share the same antimicrobial active, but are design for different uses. In one embodiment, one of the products is designed to clean, sanitize, or disinfect hard surfaces. In one embodiment, one of the products is designed to clean, sanitize, or disinfect the air. In one embodiment, one of the products is designed to clean, sanitize or disinfect a soft surface. These products can also be designed to remove or treat odors. These products can also be designed to remove or treat allergens.

In one aspect of the invention, the display may comprise a shelving unit. It may be advantageous for the manufacturer of the retail products to include such a shelving unit for use at retail, since a custom shelving unit may create a desirable setting for the products. In one form, the shelving unit will be sized to fit comfortably within the specific confines of standard retail shelving and will be shaped and colored to emphasize the cohesive nature of the combination of products that are placed in the shelf as discussed herein.

In one aspect of the invention, one or more of the group of products forming the display will be displayed on a support or “podium.” We have found that the use of such a podium in this manner presents an attractive and cohesive display. Where a podium is used, the face of the podium may be used to display a logo, trademark or text that further enhances the customer-facing display. The podium can be multi-tiered.

In one aspect of the invention, the display may contain a multi-pack. A multi-pack contains a plurality of containers packaged together. As used herein, the term “multi-pack” generically refers to products comprising two or more different containers in a common package. As used herein, the phrase “common package” refers to a sealed package used to distribute the final product. The phrase “common package” includes a unitary package housing all of the containers of the final product being distributed/sold to the consumer; a unitary package housing smaller, individual packages or units which each house containers of the final product being distributed/sold to the consumer; and/or a set of individual unitary packages grouped together to form a the final product being distributed/sold to the consumer. As such, the phrase “common package” includes but is not limited to paperboard or plastic containers or cans; and individually sealed packages which are connected together (e.g. by glue, string, shrink wrap, etc.) to form the final product being distributed/sold to the consumer.

System for Treating Cleaning Tasks

One type of system for treating cleaning tasks is a retail display. Another is a system that is advertised in a catalogue, a pamphlet, a computer screen, a printed ticket, a kiosk, a sign, a product container, an advertisement, a product display, an Internet website, and a combination thereof. A system can include a display in relationship to any distributor, store, internet sale provider, or any other entity that provides such products directly or indirectly to a consumer.

Uses

In one aspect of the invention, the products have target uses such as hard surfaces, soft surfaces, and air. In some aspects of the invention, the products have target uses that include human and animal surfaces.

Examples of hard surfaces to which the invention can be applied include surfaces composed of refractory materials such as: glazed and unglazed tile, porcelain, ceramics as well as stone including marble, granite, and other stones surfaces; glass; metals; plastics e.g. polyester, vinyl; Fiberglas, Formica®, Corian® and other hard surfaces known to the industry. Other hard surfaces include lavatory fixtures such as shower stalls, bathtubs and bathing appliances (racks, shower doors, shower bars) toilets, bidets, wall and flooring surfaces. Further hard surfaces include painted surfaces and those associated with kitchen environments and other environments associated with food preparation, including cabinets and countertop surfaces as well as walls and floor surfaces especially those which include refractory materials, plastics, Formica®, Corian® and stone.

Examples of soft surfaces include fabrics, textiles, carpets, rugs, chairs and other furniture, draperies and the like made from natural and man-made fibers.

In one embodiment, the products can be supplied to the air in various facilities, which include but are not limited to rooms, houses, hospitals, offices, theaters, buildings, and the like, or into various vehicles such as trains, subways, automobiles, airplanes and the like.

In one embodiment, the compositions of the invention can be used for a food rinse, for cleaning food-contact surfaces, or for toxicologically safe cleaning. This may involve the use of food-safe ingredients, GRAS ingredients, or ingredients with low toxicologically impact. Methods describing this use and possible compositions can be found in U.S. Pat. No. 6,455,086, U.S. Pat. No. 6,313,049, U.S. 2002/0132742, U.S. 2001/0014655, WO99/00025, and U.S. 2002/0151452. In one embodiment, the compositions are safe for use without rinsing on food-contact surfaces. In one embodiment the compositions sanitize or disinfect food-contact surfaces. In one embodiment, the compositions kill 99% of E. coli in 2 to 5 min on food-contact surfaces. In one embodiment, the composition leaves less than 20 ppm, or less than 10 ppm or less than 5 ppm or less than 1 ppm organic residue on food-contact surfaces.

In one embodiment, the products can be used as a disinfectant, sanitizer, and/or sterilizer. As used herein, the term “disinfect” shall mean the elimination of many or all pathogenic microorganisms on surfaces with the exception of bacterial endospores. As used herein, the term “sanitize” shall mean the reduction of contaminants in the inanimate environment to levels considered safe according to public health ordinance, or that reduces the bacterial population by significant numbers where public health requirements have not been established. An at least 99% reduction in bacterial population within a 24 hour time period is deemed “significant.” As used herein, the term “sterilize” shall mean the complete elimination or destruction of all forms of microbial life and which is authorized under the applicable regulatory laws to make legal claims as a “Sterilant” or to have sterilizing properties or qualities.

In one embodiment, the products can be used to remove, denature or inactivate allergens or allergen generating species. As used herein, the term “allergen” refers to “the ability of certain materials to induce specific manifestations of hypersensitivity in man . . . and the associated special antibodies in the serum of such patients are known as reagins.” K. Landsteiner, THE SPECIFICITY OF SEROLOGICAL REACTIONS 9 (Dover Publications, NY, rev. ed. 1962), which is hereby incorporated by reference. A reagin is defined as an antibody found in the blood of individuals having a genetic predisposition to allergies. Allergy is the study and treatment of human hypersensitivity reactions producing a pathogenic response to nonself molecules termed allergens. Hypersensitivity (allergic) responses are a type of immune response. Antigens that induce hypersensitivity responses are known as allergens.

Dust mites, house dust, animal dander, animal hair, and the like, represent a mix of substances that contain allergens. Not all substances found in dust mite, house dust, animal dander, animal hair, etc. are capable of inducing an immune response, much less an allergic response. Some of these substances are antigens. They will induce a specific immune response. Some of these antigens are also allergens—they will induce a hypersensitivity response in susceptible individuals. Common allergens present indoors include, but are not limited to, Dermarophagoides pteronyssinus and Dermatophagoides farinae (both from dust mites), Felis domesticus (from cats), Canis familiaris (from dogs), Blatella germanica (from German cockroach), Penicillium, Aspergillus and Cladosporium (from fungi), as well as allergens from outdoors that enter the indoor environment, eg., pollen allergens.

As used herein, the term “allergy-related product” refers to products that are marketed to help relieve and/or prevent allergy-related symptoms or control allergens, as well as the source of allergens, such as dust mites. Allergy-related products include, but are not limited to: non-prescription drugs; prescription drugs, especially including, but not limited to, antihistamines, antiinflammatory drugs, glucocorticosteroids, beta-adrenergics and leukotriene modifiers or antagonists; products that control and/or kill the sources of allergens, such as dust mites, including, but not limited to, carpet powders, household sprays, pillowcases, and mattress covers; air filters; HEPA filters; vacuums, especially those with HEPA filters; air purification devices; air pollution monitors; books (especially those relating to the treatment of allergy-related symptoms); face masks for filtering air; water filters (especially those for use in showers and/or bathtubs); household cleaning products, including, but not limited to, hard surface cleaning detergents (especially for floors and countertops), dusting sprays (especially for dusting and/or polishing furniture and household surfaces), and laundry detergents and/or additives capable of controlling and/or killing allergens and the sources thereof; personal cleansing products for either humans and/or animals including, but not limited to, bar soaps, liquid soaps, shampoos, and skin lotions; and the like. As defined herein, the term “allergy-related product” further includes the present cleaning sheets, implements, and articles of manufacture.

In one embodiment, the products can be used on food preparation surfaces and can contain only food-safe ingredients. Compositions for use herein may contain only materials that are food grade or GRAS, including, of course, direct food additives affirmed as GRAS, to protect against possible misuse by the consumer. Failure to rinse thoroughly after cleaning is less of a concern if all of the ingredients are GRAS and/or food grade. In the United States of America, the use and selection of cleaning ingredients for the purpose of washing fruits and vegetables is described by the United States Code of Federal Regulations, Title 21, Section 173.315: “Ingredients for use in washing or lye peeling of fruits and vegetables”. These regulations restrict the ingredients that can be used for direct contact with food to those described as “generally regarded as safe” (GRAS), and a few other selected ingredients. These sections also provide certain limitations on the amount of material that can be used in a given context.

In one embodiment, the present invention encompasses the method of spraying an effective amount of the composition for reducing malodor onto household surfaces. The composition may reduce malodors by chemically destroying or breaking down the malodor or cause of the malodor. The household surfaces can be selected from the group consisting of countertops, cabinets, walls, floors, bathroom surfaces and kitchen surfaces. Other suitable household surfaces include pet areas, pet litter, litter boxes, pet bowls, and pets. The present invention encompasses the method of spraying a mist of an effective amount of the composition for reducing malodor onto fabric and/or fabric articles. The fabric and/or fabric articles can include, but are not limited to, clothes, curtains, drapes, upholstered furniture, carpeting, bed linens, bath linens, tablecloths, sleeping bags, tents, car interior, e.g., car carpet, fabric car seats, etc. The present invention relates to the method of spraying a mist of an effective amount of the composition for reducing malodor impression into the air to absorb malodor. The present invention relates to the method of spraying a mist of an effective amount of the composition for reducing malodor impression onto cat litter, pet bedding and pet houses to absorb malodor. The present invention relates to the method of spraying a mist of an effective amount of the composition for reducing malodor impression onto household pets to absorb malodor.

Product Containers

Any container adapted to deliver a spray of droplets as defined herein is suitable for use herein. Several modifications can be made to the conventional, single aperture, spray head to ensure that a spray of such droplets as required herein is formed. Suitable containers to be used herein (also called “spray dispensers”) share the common feature of having at least one aperture or a plurality of apertures also called “dispensing openings” through which the composition is dispensed so as to produce the spray of droplets as defined herein. Examples of suitable containers are disclosed in U.S. Pat. App. 2005/0221113 to Bitowft et al., which is hereby incorporated within.

The container herein can comprise a spray dispenser. The composition may be dispersed into the air. The composition may be dispersed using an atomizer, an ultrasonic sprayer, a humidifier, a vaporizer, a nebulizer, or a spray device. The composition may be delivered on a continuous basis, such as with a humidifier. The composition may be delivered on a pulsed basis, such as with a canister on a timer. One spray device is an electrostatic sprayer, as described in PCT App. WO01/20988. The composition may be applied to skin surfaces. The composition may be delivered from a variety of containers, such as a dual chambered bottle, a trigger spray bottle, an aerosol canister, and a bleach pen. The composition may be applied as a foam to soft or hard surfaces.

The composition is placed into a spray dispenser in order to be distributed onto the target. The spray dispenser for producing a spray of liquid droplets can be any of the manually activated means as is known in the art, e.g. trigger-type, pump-type, non-aerosol self-pressurized, and aerosol-type spray means, for adding the composition to small surface areas and/or a small number of targets, as well as non-manually operated, powered sprayers for conveniently adding the composition to large surface areas and/or a large number of targets. Suitable manually activated sprayers and non-manually activated sprayers for use with the compositions of the current invention are described, e.g., in U.S. Pat. No. 5,783,544 and U.S. Pat. No. 5,997,759 to Trinh et al., both of said patents are incorporated herein by reference. Additional sprayers are disclosed in U.S. Pat. No. 5,294,025 to Foster; U.S. Pat. No. 4,082,223 to Nozawa; U.S. Pat. No. 4,161,288 to McKinney; U.S. Pat. No. 4,558,821 to Tada et al.; U.S. Pat. No. 4,434,917 to Saito et al.; and U.S. Pat. No. 4,819,835 to Tasaki, all of said patents being incorporated herein by reference.

These spray dispensers may be manually or electrically operated. Typical manually operated spray dispensers include pump operated ones to trigger operated ones. Indeed, in such a container with a spray dispenser head the composition contained in the container is directed through the spray dispenser head via energy communicated to a pumping mechanism by the user as said user activates said pumping mechanism or to an electrically driven pump. In one embodiment, the means for delivering the composition comprises an electrically driven pump and a spray arm being either extended or extendible and having at least one dispensing opening so that in operation, the composition is pumped by electrically driven pump from the container, through the spray arm to the dispensing opening from which it is dispensed. In this embodiment, the spray arm communicates with the container by means of a flexible connector. The spray arm may have one nozzle or multiple nozzles located along its length. The spray arm makes it easier to control where the composition is sprayed. The electrically driven pump may be, for example, a gear pump, an impeller pump, a piston pump, a screw pump, a peristaltic pump, a diaphragm pump, or any other miniature pump. The spray arm may be extensible either by means of telescopic or foldable configuration.

The compositions herein can be used by placing them in an aerosol dispenser. An aerosol dispenser comprises a container which can be constructed of any of the conventional materials employed in fabricating aerosol containers, including plastics, aluminum, and tin plate. The dispenser must be capable of withstanding internal pressure in the range of from about 20 to about 110 p.s.i.g., more preferably from about 20 to about 70 p.s.i.g. The one important requirement concerning the dispenser is that it be provided with a valve member, which will permit the composition contained in the dispenser to be dispensed in the form of a spray of particles or droplets. The aerosol dispenser utilizes a pressurized sealed container from which the composition is dispensed through a special actuator/valve assembly under pressure. The aerosol dispenser is pressurized by incorporating therein a gaseous component generally known as a propellant. Suitable propellants are compressed air, nitrogen, inert gases, carbon dioxide, gaseous hydrocarbons such as isobutene, etc. A more complete description of commercially available aerosol-spray dispensers appears in U.S. Pat. No. 3,436,772 to Stebbins; and U.S. Pat. No. 3,600,325 to Kaufman et al.; both of said references are incorporated herein by reference.

The composition may be stored or shipped in a variety of containers, including glass, ABS, polycarbonate, high density polyethylene, low density polyethylene, high density polypropylene, low density polypropylene, polyethylene terephthalate, or polyvinylchloride. A variety of additives in the container may affect the stability of the composition. For instance, the density of the polyethylene resin may be modified by co-polymerizing with a small amount of a short chain alkylene, e.g., butene, hexene or octene. Various other additives can be added, such as colorants, UV blockers, opacifying agents, and antioxidants, such as hindered phenols, e.g., BHT, Irganox 1010 (Ciba-Geigy A.G.), Irganox 1076 (Ciba-Geigy A.G.), Ionol (Shell Chemical Co.). Mold release agents and plasticizers can be added, especially to other types of plastics. The containers may have barrier films to increase storage stability. Suitable barrier films may include nylons, polyethylene terephthalate, fluorinated polyethylenes, and Barex (a copolymer of acrylonitrile and methylmethacrylate that is available from British Petroleum).

The composition may be prepared by mixing a solid composition with water. The solid composition may be a tablet, granular composition, paste, or other solid composition. The composition may be prepared by diluting a liquid composition with water. The water may be purified. The composition may be prepared by mixing two liquids, for example, from a dual chambered container or a dual chambered spray bottle. The composition may be produced by chemical or electrical means, for example by electrolysis.

The compositions of the invention can be diluted prior to use with tap water or water of higher purity. Preparation of dilute compositions for storage, for example as pre-diluted in bottles, may require water of higher purity. This higher purity water can be obtained by a variety of processes, including for example, distillation, filtering, sodium cation exchange (soft water), hydrogen cation exchange (deionized water without anion exchange), reverse osmosis, activated carbon treatment, ultrafiltration, nanofiltration, electrodialysis, and UV light treatment.

The compositions of the invention can be diluted prior to use from a concentrated liquid or solid composition. For instance, liquid sodium hypochlorite optionally containing surfactants or other additives of 5.25% available chlorine concentration can be diluted to below 500 ppm available chlorine concentration. Tablets or powders having solid hypochlorite or hypochlorite generators can be dissolved in water to deliver compositions below 500 ppm concentration. Examples of compositions that can be diluted are described in U.S. Pat. No. 6,297,209, U.S. Pat. No. 6,100,228, U.S. Pat. No. 5,851,421, U.S. Pat. No. 5,688,756, U.S. Pat. No. 5,376,297, U.S. Pat. No. 5,034,150, U.S. Pat. No. 6,534,465, U.S. Pat. No. 6,503,877, U.S. Pat. No. 6,416,687, U.S. Pat. No. 6,180,583, and U.S. Pat. No. 6,051,676. The compositions will typically be diluted with an aqueous liquid, usually tap water, prior to use. When diluted, the compositions comprise from about 40 ppm to about 12,500, preferably from about 50 ppm to about 200 ppm of registered disinfectant.

The compositions of the invention can be delivered as part of a multi-compartment delivery system, for example as described in U.S. Pat. No. 5,954,213, U.S. Pat. No. 5,316,159, WO2004/014760, U.S. Pat. No. 6,610,254, and U.S. Pat. No. 6,550,694.

Antimicrobial Actives and Registered Actives

In one embodiment the active is an antimicrobial active. In one embodiment the active is sufficient to satisfy the requirements for US EPA registration as a sanitizer or disinfectant. Certain chemical compositions for disinfecting, sanitizing, and deodorizing, including acidic materials, antibacterial materials, and solvents that kill bacteria require EPA registration as a pesticide for health concerns. The requirements for different surfaces and target areas are different. Thus, an active registered to sanitize a hard surface may not be effective or registered to sanitize a soft surface.

Hypohalous Acid and Salts

In one embodiment, the compositions comprise hypohalite, defined as hypohalous acid and/or salts thereof. Suitable hypohalous acids and salts may be provided by a variety of sources, including compositions that lead to the formation of positive halide ions and/or hypohalite ions, as well as compositions that are organic based sources of halides, such as chloroisocyanurates, haloamines, haloimines, haloimides and haloamides, or mixtures thereof. These compositions may also produce hypohalous acid or hypohalite species in situ. Suitable hypohalous acids and salts for use herein include the alkali metal and alkaline earth metal hypochlorites, hypobromites, hypoiodites, chlorinated trisodium phosphate dodecahydrates, potassium and sodium dichloroisocyanurates, potassium and sodium trichlorocyanurates, N-chloroimides, N-chloroamides, N-chlorosulfamide, N-chloroamines, chlorohydantoins such as dichlorodimethyl hydantoin and chlorobromo dimethylhydantoin, bromo-compounds corresponding to the chloro-compounds above, and compositions which generate the corresponding hypohalous acids, or mixtures thereof.

In one embodiment wherein the compositions herein are liquid, said hypohalite compositions is an alkali metal and/or alkaline earth metal hypochlorite, or mixtures thereof. Compositions may be an alkali metal and/or alkaline earth metal hypochlorite selected from the group consisting of sodium hypochlorite, potassium hypochlorite, magnesium hypochlorite, lithium hypochlorite and calcium hypochlorite, and mixtures thereof.

The hypohalous acids and salt composition may be an equilibrium mixture of hypochlorous acid and sodium hypochlorite. The active species is present in an amount from above zero to about 15 weight percent of the composition, or from about 0.001 weight percent (10 ppm) to about 10 weight percent of the composition, or from about 0.005 (50 ppm) to about 5 weight percent of the composition, or from about 0.005 (50 ppm) to about 0.02 (200 ppm) weight percent of the composition.

The amount of available halogen oxidant in the composition is determined by placing samples of the composition into about 50 milliliters of distilled water, followed by addition of about 10 milliliters of a 10 weight/weight percent solution of potassium iodide and addition of about 10 milliliters of a 10 volume percent solution of sulfuric acid, the resulting mixture being well stirred. The resulting yellow to brown solution, whose color is the result of oxidation of free iodine ion (I⁻) to molecular iodine (I₂), was then volumetrically titrated to an essentially colorless endpoint by addition of standardized 0.1 Molar sodium thiosulfate (Na₂S₂O₃) titrant. Calculation then expresses the result as percent of available molecular chlorine (Cl₂), that is to say assigning two equivalents per mole of titrated hypohalite oxidant. Stability results are then expressed by repeated assays over time using identically prepared samples resulting from the same composition, normalized to 100 percent representative of the starting available chlorine measured initially.

During the course of evaluating various oxidants and antimicrobials for their allergen deactivating ability, we have found that a very dilute solution (on the order of 40-80 ppm) of primarily hypochlorous acid can effectively deactivate allergens. Presumably the low levels of oxidant are still able to break up the allergen proteins, rendering them biologically inert.

Additional descriptions of dilute hypochlorite and packaging technology are found in Co-pending U.S. Pat. App. 2005/0232848, entitled “Packaging for Dilute Hypochlorite”; Co-pending U.S. Pat. App. 2005/0221113, entitled “Packaging for Dilute Hypochlorite”; Co-pending Application U.S. Pat. App. 2005/0232847, entitled “Method for Diluting Hypochlorite”; and Co-pending Application U.S. Pat. App. 2005/0214386, entitled “Methods for deactivating allergens and preventing disease”, and all or which are incorporated herein.

The anodic oxidation of chloride in an electrolysis cell results in the production of a number of oxychlorine ions including hypochlorite, chlorite, chlorate, and perchlorate. Chlorite is readily oxidized to chlorate. Perchlorate may be an undesirable contaminant in the environment due to its low reactivity, high mobility, and inhibition of thyroid function. The production of hypochlorite via chlorination of caustic water is not believed to result in the formation of perchlorate. This route may be advantageous for certain uses where minor amounts of perchlorate would be undesirable.

Other Antimicrobial Actives

Suitable antimicrobial agents include quaternary ammonium compounds. Non-limiting examples of these quaternary compounds include benzalkonium chlorides and/or substituted benzalkonium chlorides, di(C₆- C₁₄)alkyl di short chain (C₁₋₄ alkyl and/or hydroxyalkl) quatemaryammonium salts, N-(3-chloroallyl) hexaminium chlorides, benzethonium chloride, methylbenzethonium chloride, and cetylpyridinium chloride. Other quaternary compounds include the group consisting of dialkyldimethyl ammonium chlorides, alkyl dimethylbenzylammonium chlorides, dialkylmethylbenzylammonium chlorides, and mixtures thereof. Biguanide antimicrobial actives including, but not limited to polyhexamethylene biguanide hydrochloride, p-chlorophenyl biguanide; 4-chlorobenzhydryl biguanide, halogenated hexidine such as, but not limited to, chlorhexidine (1,1′-hexamethylene-bis-5-(4-chlorophenyl biguanide) and its salts are also in this class. There are three principal suppliers of quaternary based antimicrobials that are registered as actives for this type of use with the EPA. These companies are Lonza, Stepan and Mason Chemical Company. The trade names under which they are marketed are Bardac, BTC and Maquat respectively.

Suitable antibacterial metal salts include salts of metals in groups 3b-7b, 8 and 3a-5a. Specifically are the salts of aluminum, zirconium, zinc, silver, gold, copper, lanthanum, tin, mercury, bismuth, selenium, strontium, scandium, yttrium, cerium, praseodymiun, neodymium, promethum, samarium, europium, gadolinium, terbium, dysprosium, holmium, erbium, thulium, ytterbium, lutetium and mixtures thereof. Suitable metallic antimicrobials include silver compounds as described in U.S. Pat. No. 6,180,584 to Sawan.

Suitable phenolic antimicrobials include o-penyl-phenol, o-benzyl(p-chlorophenol), 4-tertamylphenol and mixtures thereof.

Suitable essential oil antimicrobials include those essential oils which exhibit anti-microbial activity. By “actives of essential oils”, it is meant herein any ingredient of essential oils that exhibit anti-microbial activity. It is speculated that said anti-microbial essential oils and actives thereof act as proteins denaturing agents. Such anti-microbial essential oils include, but are not limited to, those obtained from thyme, lemongrass, citrus, lemons, orange, anise, clove, aniseed, pine, cinnamon, geranium, roses, mint, lavender, citronella, eucalyptus, peppermint, camphor, ajowan, sandalwood, rosmarin, vervain, fleagrass, lemongrass, ratanhiae, cedar and mixtures thereof. Suitable anti-microbial essential oils to be used herein are thyme oil, clove oil, cinnamon oil, geranium oil, eucalyptus oil, peppermint oil, citronella oil, ajowan oil, mint oil or mixtures thereof. Actives of essential oils to be used herein include, but are not limited to, thymol (present for example in thyme, ajowan), eugenol (present for example in cinnamon and clove), menthol (present for example in mint), geraniol (present for example in geranium and rose, citronella), verbenone (present for example in vervain), eucalyptol and pinocarvone (present in eucalyptus), cedrol (present for example in cedar), anethol (present for example in anise), carvacrol, hinokitiol, berberine, ferulic acid, cinnamic acid, methyl salicylic acid, methyl salycilate, terpineol, limonene and mixtures thereof. Suitable actives of essential oils to be used herein are thymol, eugenol, verbenone, eucalyptol, terpineol, cinnamic acid, methyl salicylic acid, limonene, geraniol or mixtures thereof.

Suitable oxidant antimicrobials include hydrogen peroxide and other peroxides, sources of hydrogen peroxide and other peroxides, generators of hydroxyl radical, peracid bleaches and peracid bleach precursors, as described in U.S. Pat. No. 6,548,467 to Baker et al. and U.S. Pat. No. 6,627,590 to Sherry et al.

Suitable acid antimicrobials include: citric acid, cresylic acid, dodecylbenzene sulfonic acid, phosphoric acid, salicylic acid, sorbic acid, sulfamic acid, acetic acid, benzoic acid, boric acid, capric acid, caproic acid, cyanuric acid, dihydroacetic acid, dimethylsulfamic acid, propionic acid, polyacrylic acid, 2-ethyl-hexanoic acid, formic acid, fumaric acid, 1-glutamic acid, isopropyl sulfamic acid, naphthenic acid, oxalic acid, phosphorus acid, valeric acid, benzene sulfonic acid, xylene sulfonic acid, as well as any acid listed as a registered pesticide active ingredient with the United States Environmental Protection Agency. Further useful acids include: sulfonic acids, maleic acid, acetic acid, adipic acid, lactic acid, butyric acid, gluconic acid, malic acid, tartaric acid, as well as glycolic acid. Desirably glycolic acid and citric acid are used as they are effective and in plentiful supply.

Antimicrobial agents are present, suitably at levels below about 0.5%, or below about 0.4%, or below 0.1%.

Other Product Components

Other suitable components in any suitable amount may be used. Suitable ingredients include, but are not limited to: aesthetic agents, anti-filming agents, antiredopsition agents, anti-spotting agents, beads, binders, bleach activators, bleach catalysts, bleach stabilizing systems, bleaching agents, brighteners, buffering agents, builders, carriers, chelants, clay, color speckles, control release agents, corrosion inhibitors, dishcare agents, disinfectant, dispersant agents, dispersant polymers, draining promoting agents, drying agents, dyes, dye transfer inhibiting agents, enzymes, enzyme stabilizing systems, fillers, free radical inhibitors, fungicides, germicides, hydrotropes, opacifiers, perfumes, pH adjusting agents, pigments, processing aids, silicates, soil release agents, suds suppressors, surfactants, stabilizers, thickeners, zeolite, and mixtures thereof.

### EXAMPLES

Removal of Allergens From the Air

Inhalation of airborne allergens is the primary route to trigger allergic response. Therefore, it is desirable to be able to reduce allergen levels in the air directly. A spray of a dilute hypochlorite can not only reduce the airborne allergenic particles in the air but also denature or reduce allergenicity of the particles as well. In one example, house dust containing cat and dog allergens was continuously aerosolized into a 1 cubic meter chamber until a constant level of approximately 100 ug/m3 was achieved. This level is on the order of that known for normal activity in homes. Once a constant level was reached, a dilute hypochlorite mist (pH 7 and 85 ppm, pH 5.5 and 95 ppm) with particle sizes of approximately 60 um was sprayed into the chamber for 20 seconds delivering approximately 12 ml of hypochlorite solution. Then 3 sample pumps placed around the chamber containing filters were turned on pulling air through filters to collect remaining airborne dust. ELISA testing was done to compare the allergen levels in the dust with untreated controls. Reduction levels for cat allergen were 75% vs. no spray, and 43% reduction vs. water spray. Reduction levels for dog allergen were 85% vs. no spray, and 63% vs. water spray. A spray of dilute hypochlorite of larger particle size would be less effective at removing allergens from the air.

Comparative Particle Size Distribution

The volume mean diameter D[4,3] in microns was measured for Inventive Product Containers (containing dilute hypochlorite) and Comparative commercial products using Malvern Mastersizer® Model S, Malvern Instruments, Malvern, Worcestershire, UK. The results are shown in Table 1.

TABLE 1

| Product | Mean Particle Size, um |
|---|---|
| Inventive Hard Surface Spray A | 130.6 |
| Inventive Hard Surface Spray B | 119.7 |
| Inventive Air or Soft Surface Spray C | 58.4 |
| Inventive Air or Soft Surface Spray D | 63.1 |
| Inventive Air or Soft Surface Aerosol E | 87.6 |
| Inventive Air or Soft Surface Aerosol F | 91.3 |
| Febreeze ® Original Spray | 235.3 |
| Febreeze ®Anti-Allergen Spray | 216.9 |

Microefficacy

The inventive containers were filled with compositions containing 50 to 200 ppm hypochlorite at pH 5 to pH 8. Inventive Hard Surface Spray A was effective at sanitization of bacteria such as Escherichia coli, Salmonella choleraesuis, Staphylococcus aureus, Klebsiella pneumoniae, Streptococcus pneumoniae, and Proteus mirabilis on hard surfaces such as glass. Inventive Air or Soft Surface Aerosol E was effective at sanitization of Staphylococcus aureus and Klebsiella pneumoniae on soft surfaces such as cotton.

Dye Damage and Particle Size

Although these products are generally safe for use, dye damage can occur on select dyed fabrics that are very susceptible to color change. Generally, as the mean particle size increases, so does the amount of dye-damage. The inventive containers were filled with compositions containing 50 to 200 ppm hypochlorite at pH 5 to pH 8. In one example, nineteen fabrics were treated with various Inventive Soft Surface Sprays and Aerosols. Color change (ΔE) was measured at regular intervals over the course of a multi-treatment study, representing long-term use of the sprays and aerosols. The average ΔE correlates to the mean particle size of the sprays and aerosols. For a set of Inventive Soft Surface Sprays and Aerosols containing the same amount of active ingredient, the Pearson Correlation of mean particle size and ΔE was 0.922, indicating a very strong positive correlation. (A value of 0 indicates there is no correlation, and a value of 1 indicates the maximum correlation possible.) The ΔE for an Inventive Hard Surface Spray was 3.9 (particle size of 119.7 um) and the ΔE for an Inventive Air or Soft Surface Spray was 2.0 (particle size of 63.1 um).

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

We claim:

1. A retail display combination comprising a set of products in product containers, each one of the set positioned adjacent at least one other of said set, said display comprising:
a. a first product container comprising a first dilute hypohalite composition having less than 500 ppm hypohalite in a first container;
b. a second product container comprising a second dilute hypohalite composition having less than 500 ppm hypohalite in a second container;
c. wherein said first container dispenses product having a first mean particle size distribution;
d. wherein said second container dispenses product having a second mean particle size distribution;
e. wherein said first product container is used on hard surfaces;
f. wherein said second product container has target uses selected from the group consisting of air, soft surfaces, and combinations thereof; and
g. wherein said second mean particle size distribution is smaller than said first mean particle size distribution.

2. The retail display combination of claim 1, wherein said second container is an aerosol container.

3. The retail display combination of claim 1, wherein said second container is a trigger sprayer container.

4. The retail display combination of claim 1, wherein said second mean particle size distribution is less than 100 microns.

5. The retail display combination of claim 1, wherein said first composition and said second composition are both registered with the EPA as compositions selected from the group consisting of sanitizing compositions, disinfecting compositions, and combinations thereof.

6. The retail display combination of claim 1, wherein said second product removes allergens.

7. A system for performing cleaning tasks comprising:
a. a first product comprising a first liquid, antimicrobial composition in a first container;
b. a second product comprising a second liquid, antimicrobial composition in a second container;
c. wherein said first liquid, antimicrobial composition and said second liquid, antimicrobial composition comprise a common registered active ingredient;
d. wherein said first container dispenses product having a first mean particle size distribution;
e. wherein said second container dispenses product having a second mean particle size distribution;
f. wherein said first product is used on hard surfaces;
g. wherein said second product has target uses selected from the group consisting of air, soft surfaces, and combinations thereof; and
h. wherein said second mean particle size distribution is smaller than said first mean particle size distribution.

8. The system of claim 7, wherein said first product and said second product are sold side-by-side on a store shelf.

9. The system of claim 7, wherein said first product and said second product are sold in a multi-pack.

10. The system of claim 7, wherein said common registered antimicrobial active ingredient is hypochlorite having a concentration of less than 500 ppm.

11. The system of claim 7, wherein said common registered antimicrobial active ingredient is a quaternary ammonium biocide.

12. The system of claim 7, wherein said common registered antimicrobial active ingredient is a metallic biocide.

13. The system of claim 7, wherein said common registered antimicrobial active ingredient is a phenolic biocide.

14. The system of claim 7, wherein said common registered antimicrobial active ingredient is an oxidizing agent.

15. The system of claim 7, wherein said common registered antimicrobial active ingredient is an essential oil.

16. The system of claim 7, wherein said second product is an allergy-related product.

17. The system of claim 7, wherein said second product treats malodors.

18. The system of claim 7, wherein said second product sanitizes soft surfaces.

19. The system of claim 7, wherein said first product comprises only food grade or GRAS ingredients.

20. The system of claim 7, wherein said first product requires no rinse step.

21. The system of claim 7, additionally comprising a third product comprising a third antimicrobial composition in a third container, wherein said first antimicrobial composition and said third antimicrobial composition comprise a common registered active ingredient and wherein said third average particle size distribution is smaller than said first particle size distribution.

22. The system of claim 21, wherein said first product, said second product, and said third product are sold side-by-side-by-side on a store shelf.

23. A retail display combination comprising a set of products in product containers, each one of the set positioned adjacent at least one other of said set, said display comprising:
a. a first product comprising a first antimicrobial composition in a first container;
b. a second product comprising a second antimicrobial composition in a second container;
c. wherein said first antimicrobial composition and said second antimicrobial composition comprise a common registered active ingredient;
d. wherein said first container dispenses product having a first mean particle size distribution;
e. wherein said second container dispenses product having a second mean particle size distribution;
f. wherein said first product is used on hard surfaces;
g. wherein said second product has target uses selected from the group consisting of air, soft surfaces, and combinations thereof; and
h. wherein said second mean particle size distribution is smaller than said first mean particle size distribution.
